(19) United States
(12) Patent Application Publication
(10) Pub. No.: US 2007/0002217 A1
(43) Pub. Date: Jan. 4, 2007

(54) Liquid crystal display device having increased viewing angle

(75) Inventors: Sung-Soo Chang, Seoul (KR); Woo-Hyun Kim, Seoul (KR); Ha-Young Ji, Cungcheongbuk-Do (KR)

Correspondence Address: JENKENS & GILCHRIST, P.C., 901 15TH STREET N.W., SUITE 900, WASHINGTON, DC, 20005, US

(73) Assignee: LG.PHILIPS LCD CO., LTD., Seoul (KR)

(21) Appl. No.: 11/315,340

(22) Filed: Dec. 23, 2005

(30) Foreign Application Priority Data
Jun. 30, 2005 (KR) 10-2005-0058912

(51) Int. Cl. G02F 1/1335

(52) U.S. Cl. 349/98

(57) ABSTRACT

A liquid crystal display device includes a first substrate on which unit pixels are arranged, a second substrate facing the first substrate, a liquid crystal layer formed between the first substrate and the second substrate, the liquid crystal layer having liquid crystals arranged in a first direction, a first polarization plate formed at an outer side of the first substrate, the first polarization plate having a polarization axis parallel to the first direction, and a second polarization plate formed at an outer side of the second substrate, the second polarization plate including a polarization film having a polarization axis at a right angle to the first direction and a uni-axial film having a polarization axis at a right angle to the first direction.

The present invention claims the benefit of Korean Patent Application No. 58912/2005 filed in Korea on Jun. 30, 2005, which is hereby incorporated by reference in its entirety.

### BACKGROUND OF THE INVENTION

1. Field of the Invention

The present invention relates to a liquid crystal display device, and more particularly, to a liquid crystal display device having an increased viewing angle.

2. Description of the Related Art

As the electronic society develops, demand for various types of display devices are increasing. Therefore, research is actively ongoing in flat panel display devices, such as an LCD (Liquid Crystal Display), a PDP (Plasma Display Panel), an ELD (Electro Luminescent Display), an FED (Field Emission Display), a VFD (Vacuum Fluorescent Display) and the like. Of the aforementioned flat panel display devices, the LCD has received the most attention because it is simple to mass produce and can be easily used with a driving system to implement a high picture quality. Further, the LCD is thin, lightweight and consumes a small amount of power.

The LCD device is a transmissive display device. More particularly, an LCD device displays a desired image by controlling the amount of light transmitted through each pixel by individually supplying a data signal according to image information supplied to each of the pixels, which are arranged in a matrix configuration. Such an LCD device is commonly driven by an active matrix (AM) method. In the active matrix method, a switching device, such as a thin film transistor (TFT), is positioned in each pixel. A voltage is applied to the liquid crystal molecules of a pixel through the switching device, so that the liquid crystal molecules are driven or reoriented.

LCD devices may be divided into various types of display modes according to the way the liquid crystal molecules are driven. Of the several types of display modes, a TN (twisted nematic) mode LCD device has been generally used. The TN mode LCD device drives liquid crystal molecules with an electric field that is perpendicular to the substrate of the LCD device. The voltage of the electric field determines the angel for the director of the liquid crystal molecules within a range of 0˜90° with respect to the substrate of the TN mode LCD device.

Because the liquid crystal molecules of the TN mode LCD device is driven perpendicular to the substrate, the viewing angle of such a display device is narrow. Viewing angle is an angle range in which a viewer observes the LCD device without the color or brightness of the display varying. To overcome the disadvantage of a narrow viewing angle, an in-plane switching (hereinafter, referred to as IPS) mode LCD device has been proposed in which an electric field (i.e., in-plane electric field) is generated in parallel with the substrate such that a director of liquid crystal molecules is driven in parallel to the substrate toward a direction of the electric field. When a voltage is applied to an electrode, the IPS mode LCD device forms an in-plane electric field on the substrate. The in-plane electric field reorients liquid crystal molecules horizontally, which enables a wider viewing angle.

Because liquid crystal molecules have refractive anisotropy (or birefringence), a path of light is varied depending on the direction from which the viewer observes the light from the liquid crystals. More particularly, the shape of the liquid crystals can create viewing problems. Generally, nematic liquid crystal molecules having an oval shape are commonly used. An oval shape can cause retardation depending upon whether light passes through a long axis or a short axis of the oval liquid crystal molecule. In an LCD device using oval-shaped liquid crystal molecules fabricated to have a director that operates at angles between 0˜90° with respect to the substrate, the viewing angle is narrowed. However, because the IPS mode LCD device is driven such that a director of liquid crystal molecules is always parallel to the substrate, the viewing angle is not affected by the shape of the liquid crystal molecules.

The related art IPS mode LCD device includes a plurality of bar-shaped pixel electrodes arranged in parallel with respect to data lines and a plurality of common electrodes in parallel with the pixel electrodes such that the pixel electrodes are interleaved with the plurality of common electrodes. When the related art IPS mode LCD device is driven, liquid crystal molecules between the data line and the adjacent pixel electrode can be abnormally driven. For example, after the related art IPS mode LCD device is driven, a residual voltage can occur between the data line and an adjacent pixel electrode, which causes light leakage in the related art IPS mode LCD device during the time in which a pixel should be OFF. To address this residual voltage, LCD devices have been proposed, in which liquid crystal molecules are arranged in a direction parallel to a substrate, a pixel electrode is arranged to be at a predetermined angle with respect to a data line, and an alignment layer is rubbed in a direction perpendicular to the data line so that rubbing in a horizontal direction is performed to coincide with a direction of an electric field formed by a residual voltage and an initial-alignment direction of the liquid crystal molecules.

FIG. 1 is a plan view of a unit pixel in a fringe field switching (FFS) mode related art LCD device. Referring to FIG. 1, a majority of slits 106a in a pixel electrode 106 are at a non-perpendicular predetermined angle with respect to a data line 102. A rubbing for initially aligning the liquid crystal molecules is performed perpendicularly with respect to the data line 102. As shown in FIG. 1, the FFS mode related art LCD device includes unit pixels defined by a plurality of gate lines 101 and a plurality of data lines 102 crossing the gate lines 101 at a right angle on an array substrate. In each unit pixel, a thin film transistor 104, which is a switching device for driving the unit pixel, is formed. Also, at least one slit 106a is formed in the pixel electrode 106 such that the pixel electrode 106 forms an in-plane electric field together with a common electrode (not shown) within the slit 106a. Therefore, liquid crystal molecules initially oriented by the rubbing in a direction perpendicular to the data line 102 are rotated within the slit in response to the in-plane electric field, thereby controlling an light transmitted through the pixel.

As shown in FIG. 1, the data line 102 is arranged adjacent to the pixel electrode 106. When the related art FFS mode LCD device is driven, a residual in-plane electric field perpendicular to the data line is generated by a residual voltage generated between the data line 102 and the pixel electrode 106. The orientation of the liquid crystal molecules in the area between the data line 102 and the pixel electrode 106 can be affected by the residual in-plane electric field. Therefore, if the rubbing is made in the same direction as the direction of the gate line 101, the liquid crystal molecules are initially aligned in a direction that coincides with a direction that the liquid crystal molecules are arranged by a residual voltage even if the in-plane electric field is generated by the residual voltage between the data line and the pixel electrode.

FIG. 2 is a schematic view that illustrates a viewing angle of the LCD device in which rubbing is made in the same direction as the direction of the gate line. As shown in FIG. 2, the LCD panel fabricated by rubbing in the same direction as the direction of the gate line has a disadvantage in that the viewing angle deteriorates at the right and left sides of the LCD panel. Namely, because the LCD panel in which an alignment layer is rubbed in the same direction as the direction of the gate line includes liquid crystal molecules whose director is always arranged in the same direction as the gate line. As a result, a viewing angle between the right and left sides of the substrate is greatly decreased. Further, the aforementioned LCD device in which rubbing is performed in the same direction as the gate line has deteriorated image quality because the display screen has a tendency to be yellowish in a black state when viewed from the left or right sides.

### BRIEF DESCRIPTION OF THE INVENTION

Accordingly, the present invention is directed to a liquid crystal display device having an increased viewing angle that substantially obviates one or more of the problems due to limitations and disadvantages of the related art.

An object of the present invention is to improve a viewing angle of an LCD device in which an alignment layer is rubbed in the same direction as the direction of the gate line.

Another object of the present invention is to reduce a color coordinate shift due to color variation and an inclination angle by increasing a viewing angle between left and right sides of an LCD panel in a black mode.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, there is provided a liquid crystal display (LCD) device including a first substrate on which unit pixels are arranged, a second substrate facing the first substrate, a liquid crystal layer formed between the first substrate and the second substrate, the liquid crystal layer having liquid crystals arranged in a first direction, a first polarization plate formed at an outer side of the first substrate, the first polarization plate having a polarization axis parallel to the first direction, and a second polarization plate formed at an outer side of the second substrate, the second polarization plate including a polarization film having a polarization axis at a right angle to the first direction and a uni-axial film having a polarization axis at a right angle to the first direction.

In another aspect, a liquid crystal display device includes a first substrate on which unit pixels are arranged, a second substrate facing the first substrate, a liquid crystal layer formed between the first substrate and the second substrate, the liquid crystal layer having liquid crystals arranged in a first direction, a first polarization plate formed at an outer side of the first substrate, the first polarization plate having a polarization axis parallel to the first direction, and a second polarization plate formed at an outer side of the second substrate, the second polarization plate including a poly vinyl alcohol film having a polarization axis at a right angle to the first direction and a compensation film having a polarization axis at a right angle to the first direction.

In yet another aspect, a liquid crystal display device includes a first substrate on which unit pixels are arranged, a second substrate facing the first substrate, a liquid crystal layer formed between the first substrate and the second substrate, the liquid crystal layer having liquid crystals arranged in a first direction, a first polarization plate formed at an outer side of the first substrate, the first polarization plate having a first polarization film with a polarization axis parallel to the first direction, and first and second supporting films on both sides of the polarization films, and a second polarization plate formed at an outer side of the second substrate, the second polarization plate including a second polarization film having a polarization axis at a right angle to the first direction, a compensation film having a polarization axis at a right angle to the first direction, and a third supporting film.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

FIG. 1 is a plan view of a unit pixel in a related art fringe field switching (FFS) mode LCD device;

FIG. 2 is a schematic view that illustrates a viewing angle of the related art LCD device in which rubbing is made in a horizontal direction;

FIG. 3 is a cross-sectional view of an LCD device in accordance with embodiments of the present invention;

FIG. 4 is a cross-sectional view of an LCD panel including a polarization plate structure in accordance with a first embodiment of the present invention;

FIG. 5 is a cross-sectional view of an LCD panel including a polarization plate structure in accordance with a second embodiment of the present invention; and

FIGS. 6 and 7 are graphs that respectively describe characteristics of color variation and brightness according to embodiments of the present invention as compared to the related art.

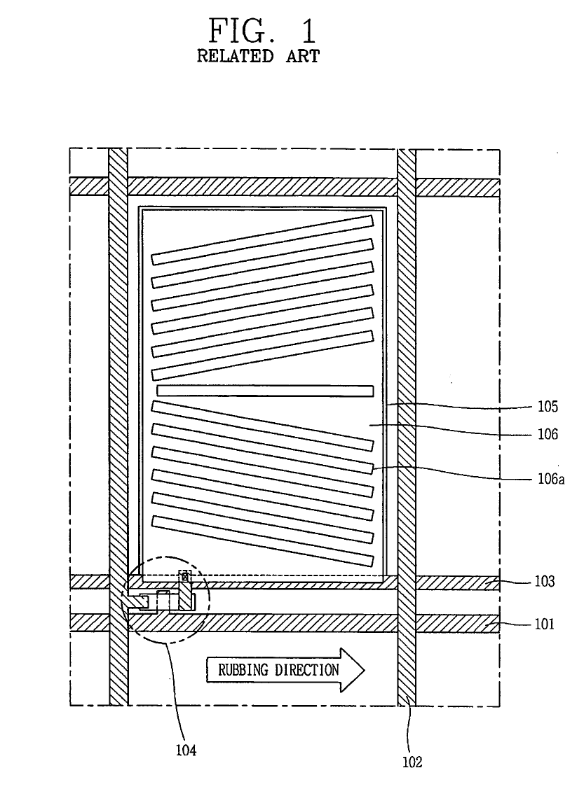

### DETAILED DESCRIPTION OF THE INVENTION

Reference will now be made in detail to the preferred embodiments of the present invention, examples of which are illustrated in the accompanying drawings.

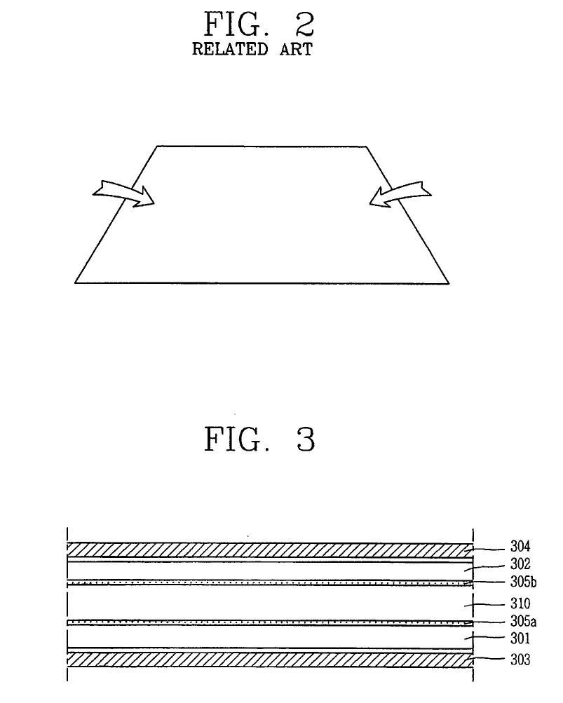

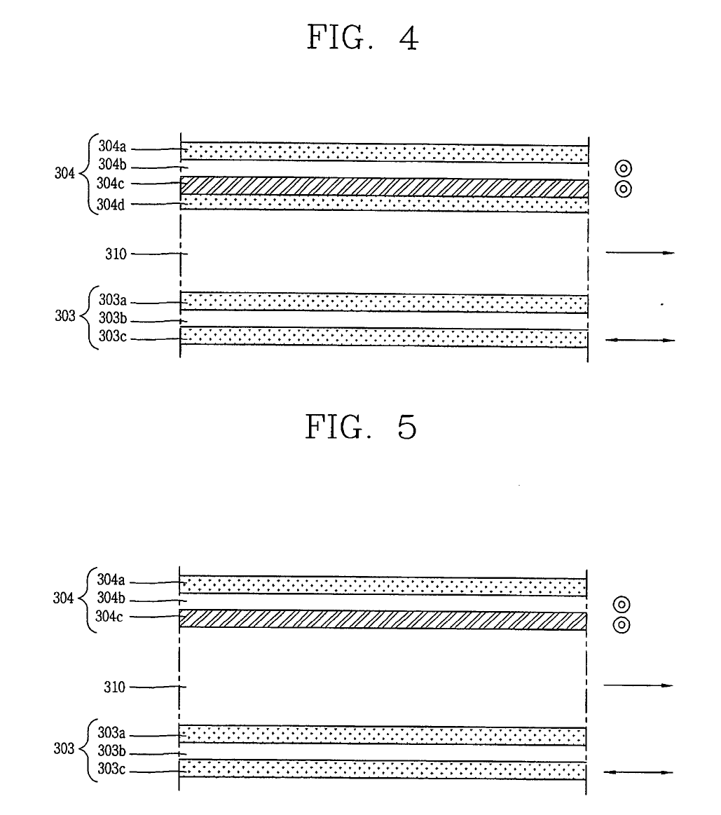

FIG. 3 is a cross-sectional view of an LCD device in accordance with embodiments of the present invention. FIG. 4 is a cross-sectional view of an LCD panel including a polarization plate structure in accordance with a first embodiment of the present invention. Arrows and symbols drawn at the right sides of FIG. 4 represent directions of transmission axes of the polarization plates, the liquid crystal layer and the uni-axial film, respectively. As shown in FIG. 3, an LCD panel in accordance with embodiments of the present invention includes a first substrate 301, which is an array substrate on which unit pixels are arranged, a second substrate 302 facing the first substrate 301, on which a color filter layer may be formed, a liquid crystal layer 310 formed between the first substrate 301 and the second substrate 302, a first polarization plate 303 attached to an outer surface of the first substrate 301, and a second polarization plate 304 attached to an outer surface of the second substrate 302. Although not shown, a plurality of gate lines and a plurality of data lines crossing the gate lines at a right angle are formed on the first substrate 301 to define unit pixels. A thin film transistor for driving the unit pixel is formed in each unit pixel. A pixel electrode and a common electrode for applying an in-plane electric field to the liquid crystal layer are also formed within each unit pixel.

A first alignment layer 305a for initial alignment of liquid crystals is formed on the first substrate 301. A second alignment layer 305b for initial alignment of liquid crystals is formed on the first substrate 302. The first and second alignment layers 305a and 305b of embodiments of the present invention are rubbed in the same direction as the direction of the gate line.

A plurality of pixel electrodes at a predetermined angle to the rubbing direction and a plurality of common electrodes respectively corresponding to the pixel electrodes are formed on the first substrate 301. In embodiments of the present invention, a super IPS (in-plane switching) mode LCD device or a fringe field switching (FFS) mode LCD device in which unit pixels may be divided into multi-domains can be used. In both cases, the direction in which the alignment layer is rubbed is the same as the direction of the gate line, which is a horizontal direction of an LCD panel. Therefore, the direction that liquid crystals are initially oriented is in the horizontal direction of the LCD panel.

As shown in FIG. 4, the first polarization plate 303 includes a poly vinyl alcohol (PVA) film 303b that substantially performs polarization and tri acetyl acetyl cellulose (TAC) films 303a and 303b supporting both sides of the PVA film 303b. The second polarization plate 304 includes a poly vinyl alcohol (PVA) film 304b that substantially performs polarization, a first tri acetyl acetyl cellulose (TAC) film 304a on one side of the PVA film 304b, a uni-axial film 304c (A-plate), which functions as compensation film formed on the other side of the PVA film 304b, and a second tri acetyl acetyl cellulose (TAC) film 304d is formed on the a uni-axial film 304c. When the liquid crystal layer 311 of the LCD panel in accordance with a first embodiment of the present invention has a retardation value of about 280-400 nm, a thickness of the TAC film is about 80 μm, and a retardation value of the uni-axial film (A-plate) is about 180 nm˜260 nm, color variation at the right and left sides of the LCD panel was significantly decreased, and variation in brightness is very small. More particularly, the display screen of the LCD panel showed a tendency to be blue in a black mode, thereby improving color.

The light transmission axis, namely, the polarization axis of the first polarization plate 303 is in the horizontal direction, which is the same as the alignment direction. The polarization axis of the PVA film 304b in the second polarization plate 304 is at a right angle to the polarization axis of the first polarization plate. Further, the polarization axis of the uni-axial film (A-plate) 304c of the second polarization plate 304 is at a right angle to the polarization axis of the first polarization plate. Thus, the first polarization plate 303 and the second polarization plate 304 have polarization axes that are perpendicular to each other, and the uni-axial film of the second polarization plate 304 has a transmission axis coinciding with the transmission axis of the polarizing film 304b in the second polarization plate. An initial transmission polarization of the liquid crystal molecules in the liquid crystal layer is parallel to the polarization axis of the first polarization plate. Under such circumstances, a viewing angle between the right and left sides of the LCD panel in which an alignment film is rubbed in the horizontal direction is significantly increased, color variation is decreased and the brightness is improved.

In general, the LCD panel in embodiments of the present invention include first and second substrates of glass plates, a polarization plate and a liquid crystal layer. The liquid crystal layer and the TAC film of the polarization plate cause retardation by affecting a path of light passing through the LCD panel. Therefore, if the thickness or the material of the liquid crystal layer is changed or if the TAC film is removed, the entire retardation value of the LCD panel is changed. Accordingly, if TAC film in the second polarization plate of the first embodiment is removed, conditions for realizing optimum image quality is changed.

FIG. 5 is a cross-sectional view of an LCD panel including a polarization plate structure in accordance with a second embodiment of the present invention. Arrows and symbols drawn at the right sides of FIG. 5 represent directions of transmission axes of the polarization plates, the liquid crystal layer and the uni-axial film, respectively. The second embodiment of the present invention will now be described with reference to FIG. 5. The first polarization plate 303 includes a PVA film 303b substantially performing a polarization function, and a TAC films 303a and 303c supporting both surfaces of the PVA film 303b. According to the second embodiment, the second polarization plate 404 includes a poly vinyl alcohol (PVA) film 304b for substantially performing polarization, a tri acetyl cellulose (TAC) film 304a supporting one surface of the PVA film 304b, and a uni-axial film 304c (A-plate), which functions as a compensation film formed at the other surface of the PVA film 304b. The second polarization plate 304 is formed by stacking the tri acetyl cellulose (TAC) film 304a, the PVA film 304b, and the uni-axial film 304c (A-plate). Thus, the second polarization plate of the second embodiment of the present invention is characterized in that the uni-axial film is used instead of a TAC film.

When the liquid crystal layer 311 of the LCD panel according to the second embodiment of the present invention had a retardation value of about 280-400 nm, a thickness of the TAC film is about 80 cm, and a retardation value of the uni-axial film (A-plate) is about 60 nm˜160 nm, color variation at the right and left sides of the LCD panel was remarkably decreased, and variation in brightness was very small. Particularly, the display screen of the LCD panel shows a tendency to be blue in a black mode, thereby improving color.

The light transmission axis, namely, a polarization axis of the first polarization plate 303 is in a horizontal direction that is the same as a direction that liquid crystals are aligned, and a polarization axis of the second polarization plate 304 is at a right angle to the polarization axis of the first polarization plate. Further, the polarization axis of the uni-axial film (A-plate) constituting the second polarization plate 304 coincides with the polarization axis of the second polarization plate 304. Thus, the first polarization plate 303 and the second polarization plate 304 have polarization axes that are perpendicular to each other, and an orienter of the liquid crystal layer has the same direction as the polarization axis of the first polarization plate, and a transmission axis of the uni-axial film constituting the second polarization plate 304 coincides with the transmission axis of the second polarization plate.

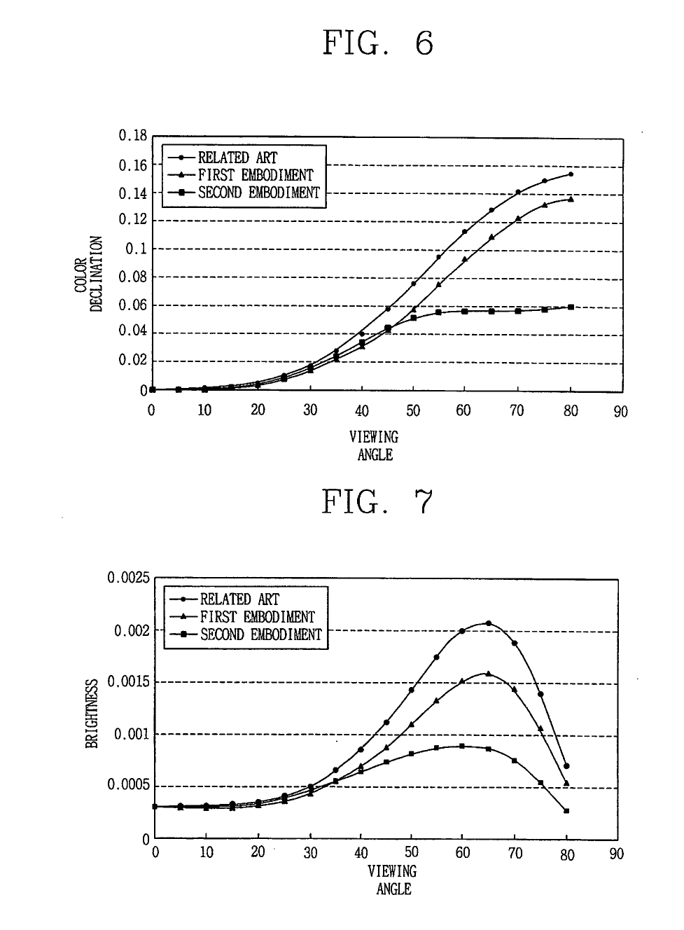

FIG. 6 shows a graph indicating a relation between inclination angles on the right and left sides and color variation of the LCD panel having the aforementioned conditions and structures. As shown in FIG. 6, it can be seen that the LCD device in accordance with the first and second embodiments have color variation values with respect to the viewing angle, which are decreased as compared to those of the related art. FIG. 7 shows a relation between a profile inclination angle and brightness in which variation in brightness according to the inclination angle in embodiments of the present invention is not greater than that of the related art LCD device. Thus, image quality of the LCD panel in embodiments of the present invention is improved because the variation in brightness and the color variation with respect to the inclination angle are not very large. More particularly, embodiments of the present invention can solve the fundamental limitation of the LCD device in that the image quality greatly varies depending on an angle that a viewer observes a screen.

As described so far, a viewing angle of the LCD device in which an alignment layer is rubbed in a horizontal direction can be increased by reducing the color variation and variation in brightness in a black mode. Thus, a viewing angle between the right and left sides of the LCD panel is increased so as to obtain an improved image quality. With such an increased viewing, a large LCD panel of high image quality can be developed for use in a television or other types of display devices.

It will be apparent to those skilled in the art that various modifications and variations can be made in the liquid crystal display device having an increased viewing angle of embodiments of the present invention without departing from the spirit or scope of the invention. Thus, it is intended that the present invention cover the modifications and variations of this invention provided they come within the scope of the appended claims and their equivalents.

What is claimed is:

1. A liquid crystal display device comprising:
a first substrate on which unit pixels are arranged;
a second substrate facing the first substrate;
a liquid crystal layer formed between the first substrate and the second substrate, the liquid crystal layer having liquid crystals arranged in a first direction;
a first polarization plate formed at an outer side of the first substrate, the first polarization plate having a polarization axis parallel to the first direction; and
a second polarization plate formed at an outer side of the second substrate, the second polarization plate including a polarization film having a polarization axis at a right angle to the first direction and a uni-axial film having a polarization axis at a right angle to the first direction.

2. The device of claim 1, wherein the first polarization plate includes a poly vinyl alcohol (PVA) film that substantially performs polarization and tri acetyl cellulose films on both inner and outer surfaces of the PVA film.

3. The device of claim 1, wherein the second polarization plate further includes a poly vinyl alcohol film as the polarization film, a first tri acetyl acetyl cellulose film on one side of the poly vinyl alcohol film, the uni-axial film formed on an other side of the poly vinyl alcohol film, and a second tri acetyl acetyl cellulose film formed on the a uni-axial film.

4. The device of claim 3, wherein the liquid crystal layer has a retardation of about 280 nm˜400 nm, a thickness of the tri acetyl acetyl film is about 80 μm, and the uni-axial film has a retardation of about 180 nm˜260 nm.

5. The device of claim 1, wherein the second polarization plate includes a poly vinyl alcohol film as the polarization film, a tri acetyl acetyl cellulose film formed at one surface of the poly vinyl alcohol film, and the uni-axial film formed at the other side of the poly vinyl alcohol film.

6. The device of claim 5, wherein the liquid crystal layer has a retardation of about 280 nm˜400 nm, a thickness of the tri acetyl acetyl cellulose film is about 80 μm, and the uni-axial film has a retardation of about 60 nm˜160 nm.

7. The device of claim 1, wherein the first substrate includes:
a plurality of gate lines arranged in a horizontal direction;
a plurality of data lines being at a right angle to the gate lines;
an alignment layer rubbed in a same direction as a direction of the gate line;
pixel electrodes formed at a non-perpendicular angle to the rubbing direction; and
common electrodes forming an in-plane electric field together with the pixel electrodes.

8. The device of claim 1, wherein the uni-axial film is a compensation film with a polarization axis.

9. A liquid crystal display device comprising:
a first substrate on which unit pixels are arranged;
a second substrate facing the first substrate;
a liquid crystal layer formed between the first substrate and the second substrate, the liquid crystal layer having liquid crystals arranged in a first direction;
a first polarization plate formed at an outer side of the first substrate, the first polarization plate having a polarization axis parallel to the first direction; and
a second polarization plate formed at an outer side of the second substrate, the second polarization plate including a poly vinyl alcohol film having a polarization axis at a right angle to the first direction and a compensation film having a polarization axis at a right angle to the first direction.

10. The device of claim 9, wherein the first polarization plate includes a poly vinyl alcohol film that substantially performs polarization and tri acetyl acetyl cellulose films on both surfaces of the PVA film.

11. The device of claim 9, wherein the second polarization plate includes a first tri acetyl acetyl cellulose film on one side of the poly vinyl alcohol film, the uni-axial film formed on an other side of the poly vinyl alcohol film, and a second tri acetyl acetyl cellulose film formed on the a uni-axial film.

12. The device of claim 11, wherein the liquid crystal layer has a retardation of about 280 nm˜400 nm, a thickness of the tri acetyl acetyl film is about 80 μm, and the uni-axial film has a retardation of about 180 nm˜260 nm.

13. The device of claim 9, wherein the second polarization plate includes a tri acetyl acetyl cellulose film formed at one surface of the poly vinyl alcohol film, and the uni-axial film formed at the other side of the poly vinyl alcohol film.

14. The device of claim 13, wherein the liquid crystal layer has a retardation of about 280 nm˜400 nm, a thickness of the tri acetyl acetyl cellulose film is about 80 μm, and the uni-axial film has a retardation of about 60 nm˜160 nm.

15. A liquid crystal display device comprising:
a first substrate on which unit pixels are arranged;
a second substrate facing the first substrate;
a liquid crystal layer formed between the first substrate and the second substrate, the liquid crystal layer having liquid crystals arranged in a first direction;
a first polarization plate formed at an outer side of the first substrate, the first polarization plate having a first polarization film with a polarization axis parallel to the first direction, and first and second supporting films on both sides of the polarization films; and
a second polarization plate formed at an outer side of the second substrate, the second polarization plate including a second polarization film having a polarization axis at a right angle to the first direction, a compensation film having a polarization axis at a right angle to the first direction, and a third supporting film.

16. The device of claim 15, wherein the first, second and third supporting films are tri acetyl acetyl cellulose and the first and second polarization films are poly vinyl alcohol.

17. The device of claim 15, wherein the liquid crystal layer has a retardation of about 280 nm˜400 nm, a thickness of each of the first, second and third supporting films is about 80 μm, and the uni-axial film has a retardation of about 60 nm˜160 nm.

18. The device of claim 15, wherein the second polarization plate includes a fourth supporting film on the compensation film.

19. The device of claim 18, wherein the first, second, third and fourth supporting films are tri acetyl cellulose and the first and second polarization films are poly vinyl alcohol.

20. The device of claim 18, wherein the liquid crystal layer has a retardation of about 280 nm˜400 nm, a thickness of each of the first, second, third and fourth supporting films is about 80 μm, and the uni-axial film has a retardation of about 180 nm˜260 nm.
